(19) United States
(12) Patent Application Publication
(10) Pub. No.: US 2026/0319965 A1
(43) Pub. Date: Oct. 15, 2026

(54) CONTROL DEVICE, DISK DRIVE, CONTROL METHOD, AND STORAGE MEDIUM

(71) Applicants: Kabushiki Kaisha Toshiba, Kawasaki-shi (JP); Toshiba Electronic Devices & Storage Corporation, Kawasaki-shi (JP)

(72) Inventor: Yukio URATA, Sagamihara Kanagawa (JP)

(21) Appl. No.: 19/464,254

(22) Filed: Jan. 29, 2026

(30) Foreign Application Priority Data
Mar. 18, 2025 (JP) 2025-043177

(51) Int. Cl. G06F 12/1027

(52) U.S. Cl. CPC G06F 12/1027

(57) ABSTRACT

A control device is a control device for a disk drive including a recording area. A plurality of LBAs are written to disk sectors other than disk sectors registered in a first defect list out of disk sectors in a first recording area in the recording area. A controller is configured to perform a formatting process based on a second defect list. The formatting process includes preparing a management table for sequentially re-assigning LBAs designated by a host device to the LBAs written to the disk sectors other than the defective disk sectors registered in the second defect list. The management table includes information that is used to replace the LBAs equal to or greater than a minimum value of the LBAs written to the defective disk sectors out of the LBAs designated by the host device with other LBAs.

### CROSS-REFERENCE TO RELATED APPLICATION

This application is based upon and claims the benefit of priority from Japanese Patent Application No. 2025-043177, filed on Mar. 18, 2025; the entire contents of which are incorporated herein by reference.

### FIELD

Embodiments described herein relate generally to a control device, a disk drive, a control method, and a storage medium.

### BACKGROUND

A control device for a disk drive that can perform a formatting process is known. Through a formatting process that is performed by such a control device, logical block addresses are assigned to a plurality of disk sectors in a recording area of the disk drive. In this formatting process, logical block addresses are written to disk sectors. Accordingly, when a defects occurs in a disk sector after the formatting process has been performed and a formatting process is preformed again, it is necessary to write logical block addresses to all the disk sectors again. Accordingly, there is a problem in that a time required for a re-formatting process increases.

### BRIEF DESCRIPTION OF THE DRAWINGS

FIG. 1 is a block diagram illustrating a configuration of a disk drive according to an embodiment.

FIG. 2 is a sectional view illustrating disks according to the embodiment.

FIG. 3 is a diagram illustrating an example of a recording surface of a disk according to the embodiment.

FIG. 4 is a diagram schematically illustrating a recording area, a first defect list, a second defect list, and a follow-up defect list of the disk drive according to the embodiment.

FIG. 5 is a diagram illustrating an example of a method of assigning LBAs in a first formatting process according to the embodiment.

FIG. 6 is a diagram illustrating an example in which some disk sectors are replaced with other disk sectors through a replacement process according to the embodiment.

FIG. 7 is a flowchart illustrating an example of a part of a process flow of a second formatting process according to the embodiment.

FIG. 8 is a diagram illustrating a relationship between LBAs designated by a host device and LBAs written to disk sectors after the second formatting process according to the embodiment has been performed.

### DETAILED DESCRIPTION

A control device according to an embodiment is a control device for a disk drive including a recording area including a plurality of disk sectors. The control device according to the embodiment includes a controller. The recording area includes a first recording area including two or more of the disk sectors. A plurality of logical block addresses are written to disk sectors other than disk sectors registered in a first defect list out of the disk sectors in the first recording area. The controller is configured to perform a formatting process based on a second defect list different from the first defect list. The disk sectors determined to be defective after the logical block addresses have been written to the disk sectors are registered in the second defect list. The formatting process includes a determination process of determining whether a disk sector to which a logical block address has been written is a defective disk sector registered in the second defect list. The formatting process includes preparing a management table for sequentially re-assigning the logical block addresses designated by a host device sending an instruction to the disk drive to the logical block addresses written to the disk sectors other than the defective disk sector. The management table includes information that is used to replace the logical block addresses equal to or greater than a minimum value of the logical block addresses written to the defective disk sectors out of the logical block addresses designated by the host device with other logical block addresses written to the disk sectors other than the defective disk sectors.

Hereinafter, a control device, a disk drive, a control method, and a storage medium according to an embodiment will be described with reference to the accompanying drawings.

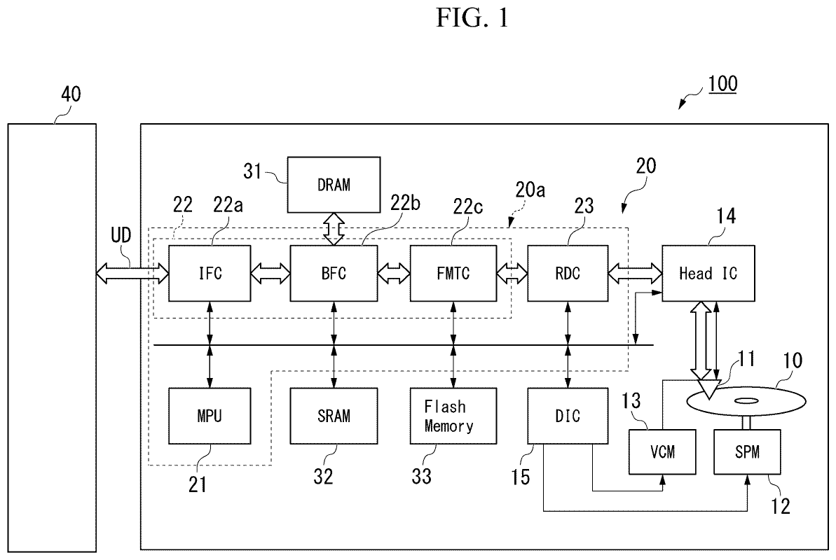

FIG. 1 is a block diagram illustrating a configuration of a disk drive 100 according to an embodiment. The disk drive 100 according to the present embodiment illustrated in FIG. 1 is a magnetic disk drive into which a hard disk drive is incorporated. The disk drive 100 can store information as digital data. The disk drive 100 is driven on the basis of an instruction from a host device 40. The host device 40 is, for example, a server or a personal computer. The host device 40 is not particularly limited as long as it is a device sensing an instruction to the disk drive 100. The host device 40 can write information to the disk drive 100 and read data recorded on the disk drive 100.

As illustrated in FIG. 1, the disk drive 100 includes a disk 10, a head 11, a spindle motor 12, a voice coil motor 13, a head amplifier IC 14, and a control device 20.

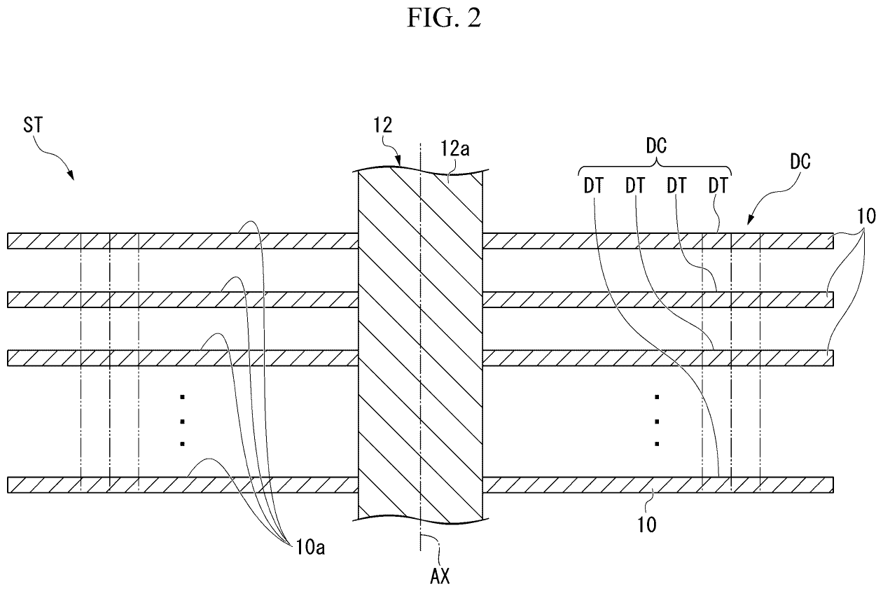

In the present embodiment, the disk 10 is a magnetic disk. The disk 10 is disk-shaped. FIG. 2 is a sectional view illustrating the disk 10. As illustrated in FIG. 2, in the present embodiment, a plurality of disks 10 are provided at intervals in an axial direction of a shaft 12a. The number of disks 10 is not particularly limited as long as the number is equal to or greater than one. The plurality of disks 10 are connected to the shaft 12a of the spindle motor 12. Each disk 10 is rotated around a center axis AX of the shaft 12a by the spindle motor 12. In the following description, a direction in which the center axis AX of the shaft 12a extends may be simply referred to as an “axial direction.” A radial direction about the center axis AX may be simply referred to as a “radial direction.” A circumferential direction around the center axis AX may be simply referred to as a “circumferential direction.”

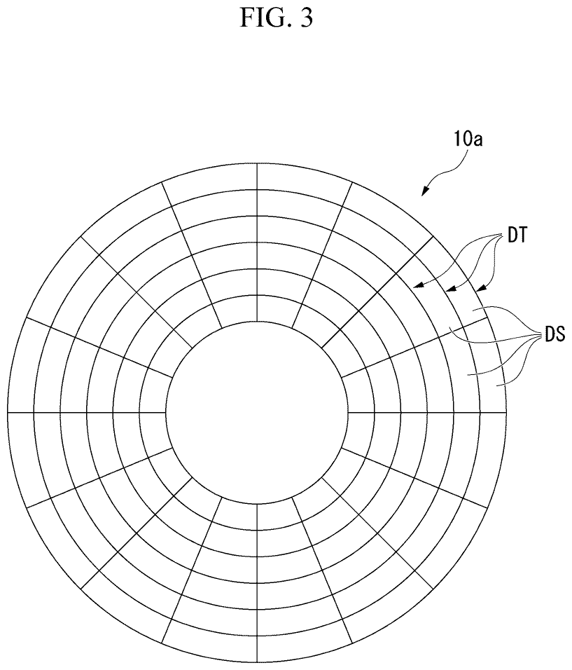

Each disk 10 includes a recording surface 10a. Both a front surface and a rear surface of each disk 10 may serve as the recording surface 10a. That is, each disk 10 may include two recording surfaces 10a. FIG. 3 is a diagram illustrating an example of a recording surface 10a of a disk 10. As illustrated in FIG. 3, a plurality of disk tracks DT with a ring shape are formed on the recording surface 10a. The plurality of disk tracks DT are concentrically arranged in the radial direction. Each disk track DT includes a plurality of disk sectors DS which are arranged in the circumferential direction. Each disk sector DS can store a predetermined amount of digital data. The storage capacity of each disk sector DS is, for example, 512 bytes. The storage capacity of each disk sector DS is not particularly limited. The number of disk sectors DS included in the recording surface 10a is not particularly limited.

The disk drive 100 according to the present embodiment includes a recording area ST including a plurality of recording surfaces 10a. The recording area ST includes a plurality of disk sectors DS on the plurality of recording surface 10a. As illustrated in FIG. 2, the recording area ST includes a plurality of disk cylinders DC. Each of the plurality of disk cylinders includes a plurality of disk tracks DT. The plurality of disk cylinders DC are arranged in parallel in the radial direction. The plurality of disk tracks DT included in each disk cylinder DC are located at the same position in the radial direction. The plurality of disk tracks DT included in each disk cylinder DC are disk tracks DT which are formed on different recording surfaces 10a. In FIG. 2, some disk cylinders DC out of the plurality of disk cylinders DC are virtually illustrated by alternate long and two short dashes lines.

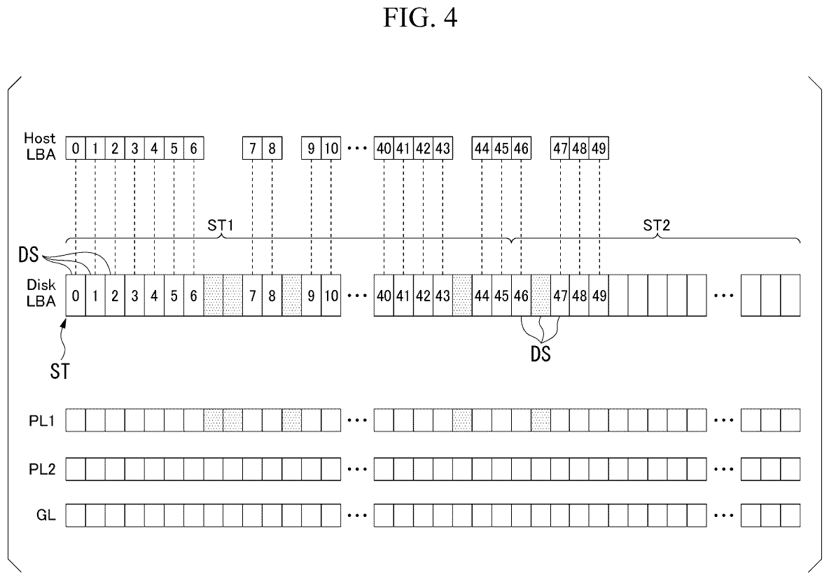

FIG. 4 is a diagram schematically illustrating the recording area ST of the disk drive 100, a first defect list PL1, a second defect list PL2, and a follow-up defect list GL. As illustrated in FIG. 4, the recording area ST includes a first recording area ST1 and a second recording area ST2. Each of the first recording area ST1 and the second recording area ST2 includes two or more disk sectors DS. The first recording area ST1 is a user data recording area in which user data UD transmitted from the host device 40 is recorded. The second recording area ST2 is an alternative area including a plurality of disk sectors DS which are used instead of the disk sectors DS of the first recording area ST1. When the disk sectors DS included in the first recording area ST1 include a disk sector DS which is determined to be unavailable, the second recording area ST2 is used as an area in which user data UD is recorded instead of the disk sector DS determined to be unavailable. The case in which a disk sector DS is determined to be unavailable includes, for example, a case in which a write and recovered error with which data cannot be written to the disk sector DS occurs and a case in which a read and recovered error with which data in the disk sector DS cannot be read occurs.

In the example illustrated in FIG. 4, shaded disk sectors DS out of a plurality of disk sectors DS are disk sectors DS registered in the first defect list PL1 which will be described later. The disk sectors DS registered in the first defect list PL1 are disk sector DS determined to be unavailable in a test or the like in the stage of manufacturing the disk drive 100. FIG. 4 illustrates an example in which five disk sectors DS are registered in the first defect list PL1. In the example illustrated in FIG. 4, four disk sectors DS in the first recording area ST1 and one disk sector DS in the second recording area ST2 are registered in the first defect list PL1. In the first defect list PL1 in the example illustrated in FIG. 4, blocks corresponding to the registered disk sectors DS are shaded.

In the example illustrated in FIG. 4, four disk sectors DS in the second recording area ST2 instead of four disk sectors DS determined to be unavailable in the first recording area ST1 are used as disk sectors DS in which user data UD is to be recorded. Logical block addresses (LBAs) are assigned to the disk sectors DS in which user data UD is to be recorded. A logical block address is a number which is assigned to identify a disk sector DS. Numbers indicating the logical block addresses are written to the disk sectors DS in which user data UD is to be recorded through a first formatting process FP1 which will be described later. In the example illustrated in FIG. 4, a plurality of logical block addresses of Nos. 0 to 49 are written to the plurality of disk sectors DS in which user data UD is to be recorded. In the example illustrated in FIG. 4, a plurality of logical block addresses of Nos. 0 to 45 are written to the disk sectors DS other than the disk sectors DS registered in the first defect list PL1 out of the disk sectors DS in the first recording area ST1. In the example illustrated in FIG. 4, a plurality of logical block addresses of Nos. 46 to 49 are written to four disk sectors DS in the second recording area ST2. In the following description, a logical block address may be referred to as “LBA.”

The head 11 illustrated in FIG. 1 is a magnetic head that can read data recorded in the disk 10 and write data to the disk 10. Although not illustrated, the head 11 includes a read head for reading data recorded in the disk 10 and a write head for writing data to the disk 10. The head 11 is moved between a position at which the head 11 faces the recording surface 10a and a position at which the head 11 does not face the recording surface 10a by the voice coil motor 13. The head 11 can perform reading of data from the recording surface 10a and writing of data to the recording surface 10a at the position at which the head 11 faces the recording surface 10a. The head 11 is provided for each recording surface 10a. A plurality of heads 11 are moved in the radial direction together by the voice coil motor 13.

Although not illustrated, the head amplifier IC 14 includes a read amplifier and a write driver. The read amplifier amplifies a signal of data read from the disk 10 by the head 11 and outputs the amplified signal to a read/write channel 23 which will be described later in the control device 20. The write driver outputs a write current corresponding to data output from the read/write channel 23 to the head 11. The head 11 writes data to the disk 10 on the basis of the write current output from the write driver. The head amplifier IC 14 is mounted, for example, on a flexible board (not illustrated) attached to a head assembly which is not illustrated and which includes the head 11. The flexible board electrically connects the head 11 to the control device 20.

The control device 20 includes a controller 20a, a driver IC 15, a first volatile memory 31, a second volatile memory 32, and a nonvolatile memory 33. The controller 20a, the driver IC 15, the first volatile memory 31, the second volatile memory 32, and the nonvolatile memory 33 are mounted on, for example, a circuit board which is not illustrated.

The driver IC 15 controls driving of the spindle motor 12 and driving of the voice coil motor 13 on the basis of an instruction from the controller 20a.

The controller 20a is a system controller that controls the disk drive 100. The controller 20a is, for example, a large scale integration (LSI) circuit called system-on-a-chip (SoC) in which a plurality of elements are integrated on a single chip. The controller 20a is electrically connected to the head amplifier IC 14, the driver IC 15, the first volatile memory 31, the second volatile memory 32, and the nonvolatile memory 33. The controller 20a includes a microprocessor 21, a hard disk controller 22, and a read/write channel 23.

The hard disk controller 22 controls data transmission between the host device 40 and the read/write channel 23 on the basis of an instruction from the microprocessor 21. The hard disk controller 22 is electrically connected to the microprocessor 21, the read/write channel 23, the read/write channel 23, the head amplifier IC 14, the driver IC 15, the first volatile memory 31, the second volatile memory 32, and the nonvolatile memory 33. The hard disk controller 22 includes an interface control unit 22a, a buffer control unit 22b, and a format control unit 22c. The interface control unit 22a controls an interface with the host device 40. The interface control unit 22a reads an instruction input from the host device 40 and performs reception and transmission of data and the like. The buffer control unit 22b temporarily stores data input from the host device 40 via the interface control unit 22a and data read from the disk 10 in the first volatile memory 31. The format control unit 22c converts formats of data input from the buffer control unit 22b and data input from the read/write channel 23.

The read/write channel 23 performs signal processing of data transmitted from the disk 10 to the host device 40 and data transmitted from the host device 40 to the disk 10 on the basis of an instruction from the microprocessor 21. The read/write channel 23 has, for example, a function of measuring signal quality of data.

The first volatile memory 31 and the second volatile memory 32 are semiconductor memories in which data stored therein disappears when supply of electric power is cut off. In the present embodiment, data is temporarily stored in the first volatile memory 31 by the buffer control unit 22b. In the present embodiment, the first volatile memory 31 is a dynamic random access memory (DRAM). Data or the like required for processing in the constituents of the disk drive 100 is stored in the second volatile memory 32. In the present embodiment, the second volatile memory 32 is a static random access memory (SRAM). The first volatile memory 31 and the second volatile memory 32 may be unified as a single volatile memory. The first volatile memory 31 may be an SRAM, a synchronous dynamic random access memory (SDRAM), a ferroelectric random access memory (FeRAM), a magnetoresistive random access memory (MRAM), or the like. The second volatile memory 32 may be a DRAM, an SDRAM, an FeRAM, an MRAM, or the like.

The nonvolatile memory 33 is a semiconductor memory in which data stored therein is continuously stored even when supply of electric power is cut off. In the present embodiment, the nonvolatile memory 33 is a flash memory. The nonvolatile memory 33 is, for example, an NOR-type or NAND-type flash memory. At least a part of a program for driving the disk drive 100, system data required before reading or writing of data with respect to the disk 10 is performed, and the like are stored in the nonvolatile memory 33.

Outlined arrows in FIG. 1 indicate a flow of user data UD. The user data UD input from the host device 40 to the disk drive 100 is input to the buffer control unit 22b via the interface control unit 22a and is temporarily stored in the first volatile memory 31 by the buffer control unit 22b. The user data UD stored in the first volatile memory 31 is read by the buffer control unit 22b and is converted into a format which can be stored in the disk 10 by the format control unit 22c. The user data UD which is a conversion result is transmitted to the head amplifier IC 14 via the read/write channel 23 and is written from the head 11 to the disk 10. When the user data UD written to the disk 10 is read by the host device 40, for example, the user data UD is read in the reversed order of the order in which the user data UD is written to the disk 10.

The microprocessor 21 is a main controller that controls the constituents of the disk drive 100. The microprocessor 21 controls the voice coil motor 13 via the driver IC 15 and performs servo control for positioning the head 11. The microprocessor 21 controls the spindle motor 12 via the driver IC 15 such that the disk 10 is rotated. The microprocessor 21 controls an operation (a writing operation) of writing data to the disk 10. The microprocessor 21 selects a storage destination of data to be written to the disk 10. The microprocessor 21 controls an operation (a reading operation) of reading data stored in the disk 10. The microprocessor 21 controls processing of data read from the disk 10. The microprocessor 21 is electrically connected to the constituents of the disk drive 100.

As illustrated in FIG. 4, the disk drive 100 includes a first defect list PL1, a second defect list PL2, and a follow-up defect list GL. The first defect list PL1, the second defect list PL2, and the follow-up defect list GL are stored, for example in the nonvolatile memory 33. The first defect list PL1, the second defect list PL2, and the follow-up defect list GL may be stored in the disk 10 or may be stored in a storage medium other than the nonvolatile memory 33 and the disk 10.

The first defect list PL1 is a list in which disk sectors DS determined to be unavailable in a test or the like in the stage of manufacturing the disk drive 100 are registered together. Before the first formatting process FP1 which will be described later is first performed, the disk sectors DS determined to be unavailable are registered in the first defect list PL1.

The second defect list PL2 is a list that is used when a second formatting process FP2 which will be described later is performed. Disk sectors DS determined to be defective after LBAs have been written to the disk sectors DS are registered in the second defect list PL2. Disk sectors DS registered in the follow-up defect list GL are registered in the second defect list PL2 in the second formatting process FP2 which will be described later. In the following description, the disk sectors DS registered in the second defect list PL2 may be referred to as defective disk sectors DDS.

The follow-up defect list GL is a list in which disk sectors DS determined to be unavailable after the first formatting process FP1 which will be described later has been first performed are registered. That is, disk sectors DS determined to be defective after LBAs have been written to the disk sectors DS are registered in the follow-up defect list GL. For example, disk sectors DS determined to be unavailable after the disk drive 100 has been shipped to a user are registered in the follow-up defect list GL.

By registering address information of the disk sectors DS determined to be unavailable in the first defect list PL1, the second defect list PL2, and the follow-up defect list GL, the disk sectors DS are registered. The address information of the disk sectors DS registered in the defect lists is address information indicating absolute positions of the disk sectors DS indicated by cylinder head sectors (CHSs). The address information of the disk sectors DS indicated by cylinder head sectors is also used to identify disk sectors DS to which LBAs are written in the first formatting process FP1 and the second formatting process FP2 which will be described later. The address information of the disk sectors DS registered in the second defect list PL2 may be LBAs written to the registered disk sectors DS. The address information of the disk sectors DS registered in the follow-up defect list GL may be LBAs written to the registered disk sectors DS.

The controller 20a is configured to perform a first registration process and a second registration process. That is, a control method for the disk drive 100 includes the first registration process and the second registration process. The first registration process is a process of registering a disk sector DS determined to be defective after LBAs have been written to the disk sectors DS in the second defect list PL2. The second registration process is a process of registering a disk sector DS determined to be defective after LBAs have been written to the disk sectors DS in the follow-up defect list GL. The controller 20a switches between a state in which a disk sector DS is registered using the first registration process and a state in which a disk sector DS is registered using the second registration process. For example, before the drive 100 has been shipped and when the disk drive 100 is recovered by a manufacturer, the state of the controller 20a is the state in which a disk sector DS is registered in the first registration process. For example, when the disk drive 100 is used by a user, the state of the controller 20a is the state in which a disk sector DS is registered using the second registration process.

The controller 20a is configured to perform the first formatting process FP1. The first formatting process FP1 is a process of sequentially assigning a plurality of LBAs to a plurality of disk sectors DS used to record user data UD. The first formatting process FP1 is performed before the disk drive 100 is used to record user data UD. The first formatting process FP1 may be performed, for example, before the disk drive 100 is shipped or may be performed by a user after it has been shipped. A command support program for causing the control device 20 to perform the first formatting process FP1 may be installed in the disk drive 100 by a user. In the present embodiment, the first formatting process FP1 is performed by the microprocessor 21.

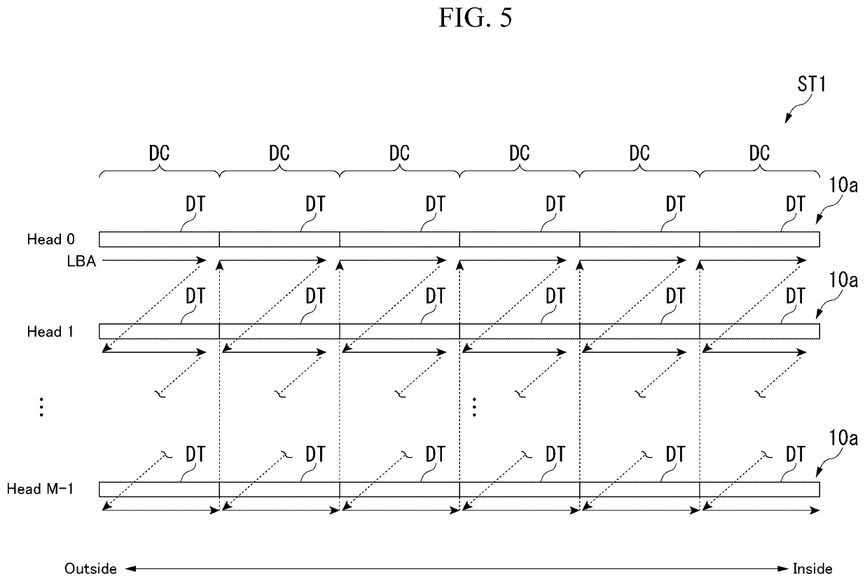

FIG. 5 is a diagram illustrating an example of a method of assigning LBAs in the first formatting process FP1. The left-right direction in FIG. 5 is a radial direction centered on a center axis AX. The right side in the left-right direction in FIG. 5 indicates the inside in the radial direction. The left side in the left-right direction in FIG. 5 indicates the outside in the radial direction. As illustrated in FIG. 5, for example, assignment of LBAs is started from the disk track DT of the recording surface 10a corresponding to the head 11 with a smallest logical number out of the disk tracks DT of the disk cylinder DC located on the outermost side in the radial direction. The logical number of a head 11 is a number which is assigned to each of a plurality of heads 11. The logical number of a head 11 is a number which is appropriately determined according to performance or the like of the head 11 regardless of a physical position of a head 11. In the example illustrated in FIG. 5, logical numbers of Nos. 0 to M-1 are assigned to M heads 11. Assignment of LBAs to a plurality of disk sectors DS in one disk track DT is performed in the order in which the plurality of sectors DS are arranged in the circumferential direction.

The LBAs are assigned to the disk tracks DT corresponding to the head 11 of No. 0 in the disk cylinder DC located on the outermost side in the radial direction and are then assigned to the disk tracks DT corresponding to the head 11 of No. 1 with a second smallest logical number in the same disk cylinder DC. Thereafter, similarly, the LBAs are sequentially assigned to the disk tracks DT in the same disk cylinder DC. When assignment of LBAs to the disk cylinder DC located on the outermost side in the radial direction is completed, LBAs are assigned a disk cylinder DC located to be adjacent on the inner side in the radial direction of the disk cylinder DC. The method of assigning the LBAs to the disk cylinder DC is the same as the method of assigning the LBAs to the disk cylinder DC located on the outermost side in the radial direction. Thereafter, similarly, LBAs are sequentially assigned to a plurality of disk cylinders DC. In the present embodiment, when the disk sectors DS included in the recording area ST are arranged in the order in which the LBAs are assigned, the second recording area ST2 is disposed subsequently to the first recording area ST1.

The first formatting process FP1 includes a writing process of writing LBAs to the disk sectors DS in the aforementioned order and a reading process of reading the LBAs written in the writing process in the order of LBAs. The first formatting process FP1 is performed on the basis of the first defect list PL1. In the first defect list PL1, the controller 20a assigns the LBAs to the disk sectors DS in the aforementioned order while skipping the disk sectors DS registered in the first defect list PL1. Accordingly, a plurality of LBAs are written to the disk sectors DS other than the disk sectors DS registered in the first defect list PL1 out of the disk sectors DS in the first recording area ST1.

In FIG. 4, a state of the recording area ST before a defect in the disk sectors DS to which the LBAs have been written has been found after the first formatting process FP1 has been completed is illustrated. FIG. 4 illustrates an example of a correlation between an LBA designated by the host device 40 and a disk sector DS of which the designated LBA is accessed by the control device 20. In the state illustrated in FIG. 4, the control device 20 accesses a disk sector DS to which an LBA of the same number as the LBA designated by the host device 40 is written when the LBA has been designated by the host device 40.

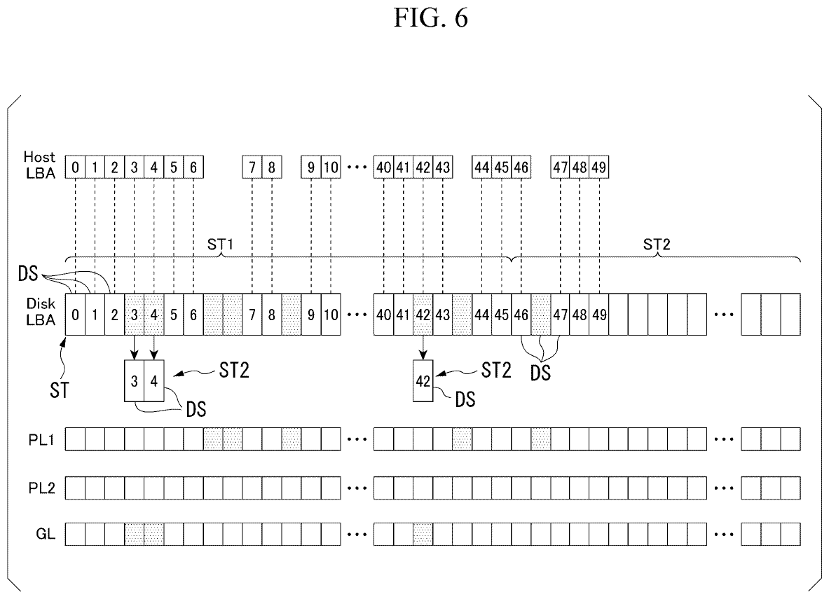

The controller 20a is configured to perform a replacement process of replacing the disk sectors DS registered in the follow-up defect list GL with other disk sectors DS. That is, the control method for the disk drive 100 includes the replacement process. FIG. 6 is a diagram illustrating an example in which some disk sectors DS are replaced with other disk sectors DS through the replacement process. FIG. 6 illustrates an example in which it is determined that a defect occurs in the disk sectors DS to which LBAs of Nos. 3, 4, and 42 have been written and the disk sectors DS to which these numbers have been written are registered in the follow-up defect list GL. In the follow-up defect list GL in the example illustrated in FIG. 6, blocks corresponding to the registered disk sectors DS are shaded.

In the replacement process, the controller 20a replaces the disk sectors DS registered in the follow-up defect list GL with other disk sectors DS in the second recording area ST2. In the replacement process, the controller 20a writes LBAs written to the disk sectors DS registered in the follow-up defect list GL to other disk sectors DS in the second recording area ST2. In the example illustrated in FIG. 6, for example, when the LBA of No. 3 is designated by the host device 40, the controller 20a accesses the disk sector DS in the second recording area ST2 to which the LBA of No. 3 has been written through the replacement process.

In the present embodiment, the controller 20a is configured to perform the second formatting process FP2. The second formatting process FP2 is a re-formatting process that is performed on the basis of the second defect list PL2. The second formatting process FP2 is a process of sequentially re-assigning LBAs designated by the host device 40 to the LBAs written to the disk sectors DS other than the defective disk sectors DDS without re-writing LBAs to the disk sectors DS to which LBAs have been written already. For example, the second formatting process FP2 may be performed before the disk drive 100 is shipped or may be performed by a user after the disk drive 100 has been shipped. A command support program for causing the control device 20 to perform the second formatting process FP2 may be installed in the disk drive 100 by a user. In the present embodiment, the second formatting process FP2 is performed by the microprocessor 21.

The second formatting process FP2 includes preparing a management table for sequentially re-assigning LBAs designated by the host device 40 to the LBAs written to the disk sectors DS other than the defective disk sectors DDS. Table 1 is a table showing an example of the management table. As shown in Table 1, a relationship between an LBA number α and a number Δ which is added at the time of replacing an LBA is shown in the management table. The LBA number α is a number of an LBA designated by the host device 40. In each row indicated by a variable Vz in the management table, a number Δ which is added at the time of replacing an LBA and an LBA number α to which the number Δ needs to be added are described.

TABLE 1

| Variable Vz | LBA number α | Added numberΔ |
|---|---|---|
| 0 | 0 | 0 |
| 1 | 3 | 2 |
| 2 | 40 | 3 |

In the row in which the variable Vz is 0 in Table 1, the LBA number α is 0, and the added number Δ is 0. In the row in which the variable Vz is 1 in Table 1, the LBA number α is 3, and the added number Δ is 2. In the row in which the variable Vz is 2 in Table 1, the LBA number α is 40, and the added number Δ is 3. The LBA number α and the added number Δ in each row of Table 1 represent that the LBA before the LBA number α of the row changes to the LBA number α of the next row needs to be replaced with an LBA to which the added number Δ of the row is added. In the example shown in Table 1, when the LBA designated by the host device 40 is equal to or greater than 0 and less than 3, the added number Δ is 0, and thus the controller 20a does not need to replace the LBA designated by the host device 40. In the example shown in Table 1, when the LBA designated by the host device 40 is equal to or greater than 3 and less than 40, the controller 20a replaces the LBA with an LBA obtained by adding 2 to the LBA and accesses the disk sector DS to which the replaced LBA is written. In the example shown in Table 1, when the LBA designated by the host device 40 is equal to or greater than 40, the controller 20a replaces the LBA with an LBA obtained by adding 3 to the LBA and accesses the disk sector DS to which the replaced LBA is written.

In the example shown in Table 1, a defective disk sector DDS to which the LBA of No. 3 has been written is a disk sector DS to which an LBA of the smallest number has been written out of the defective disk sectors DDS registered in the second defect list PL2. That is, in the example illustrated in Table 1, the minimum value of the LBAs written to the defective disk sectors DDS is 3. As described above, on the basis of the management table, the controller 20a does not replace the LBA when the LBA designated by the host device 40 is less than 3 and replaces the LBA with another LBA when the LBA designated by the host device 40 is equal to or greater than 3. In this way, the management table includes replacement information that is used to replace an LBA equal to or greater than the minimum value of the LBAs written to the defective disk sectors DDS out of the LBAs designated by the host device 40 with another LBA written to a disk sector DS other than the defective disk sectors DDS. In the present embodiment, the replacement information includes the LBA number α and the added number Δ.

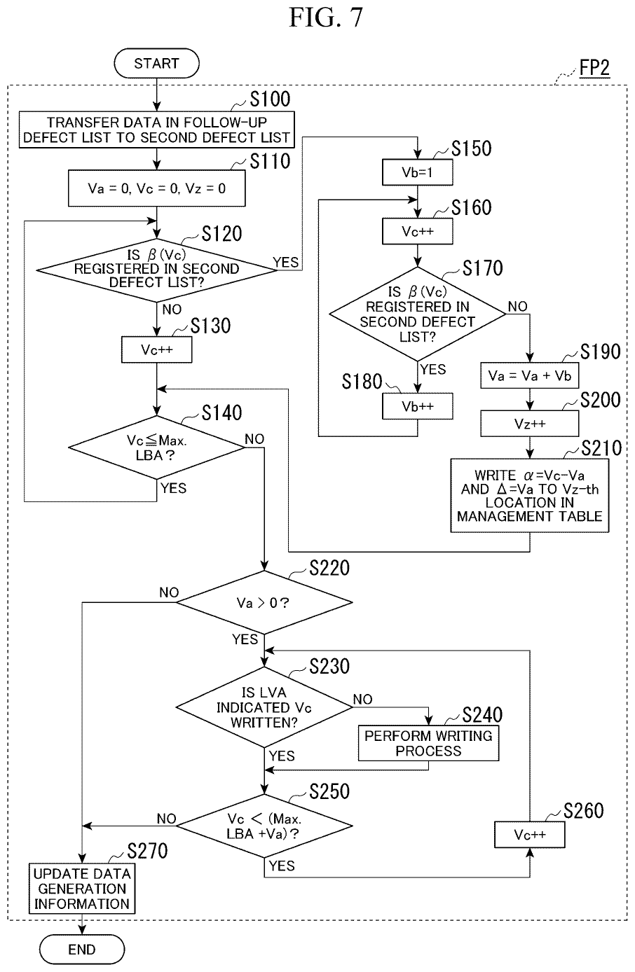

FIG. 7 is a flowchart illustrating a part of a flow process which is an example of the second formatting process FP2. In the present embodiment, the process flow of the second formatting process FP2 illustrated in FIG. 7 is performed by the microprocessor 21 of the controller 20a. FIG. 7 illustrates an example of the second formatting process FP2 that is performed in the disk drive 100 in a state in which a disk sector DS is registered in the follow-up defect list GL through the second registration process when a defect occurs in the disk sector DS.

As illustrated in FIG. 7, when the second formatting process FP2 is started, the controller 20a transfers data of the follow-up defect list GL to the second defect list PL2 (Step S100). In Step S100, the controller 20a registers the disk sectors DS registered in the follow-up defect list GL in the second defect list PL2. In Step S100, the controller 20a deletes registration information of the disk sectors DS in the follow-up defect list GL. In the second formatting process FP2 that is performed by the disk drive 100 in a state in which a disk sector DS is registered in the second defect list PL2 through the first registration process when a defect occurs in the disk sector DS, Step S100 is not performed.

Subsequently to Step S100, the controller 20a sets the values of three variables Va, Vc, and Vz to zero (Step S110). The variable Va is a variable for recording the added number Δ for replacing an LBA designated by the host device 40 with another LBA in the management table. At the time of recording in the management table, the variable Va is the same as the added number Δ. The variable Vc is a variable corresponding to the LBA number. The variable Vz is a variable indicating a position in the management table, that is, for example, the number of rows in Table 1. Step S110 may be performed before Step S100.

Subsequently to Step S110, the controller 20a determines whether a variable β (Vc) is registered in the second defect list PL2 (Step S120). That is, the second formatting process FP2 includes a determination process of determining whether a disk sector DS to which an LBA has been written is a defective disk sector DDS registered in the second defect list PL2. The determination process is performed subsequently to Step S100. That is, when a disk sector DS is registered in the follow-up defect list GL, the second formatting process FP2 includes registering the disk sector DS registered in the follow-up defect list GL in the second defect list PL2 and then performing the determination process on the basis of the second defect list PL2.

The variable β (Vc) is a variable indicating a disk sector DS to which an LBA of No. Vc has been written. In Step S120, the controller 20a determines whether the disk sector DS indicated by the variable β (Vc) is registered in the second defect list PL2. When it is determined in Step S120 that the disk sector DS indicated by the variable β (Vc) is not registered in the second defect list PL2 (Step S120: NO), the controller 20a increases the value of the variable Vc by 1 (Step S130).

Subsequently to Step S130, the controller 20a determines whether the variable Vc is equal to or less than a maximum value (Max. LBA) of the LBAs designated by the host device 40 (Step S140). In the examples illustrated in FIGS. 4 and 6 and the like, the maximum value of the LBAs designated by the host device 40 is 49. Accordingly, in the examples illustrated in FIGS. 4 and 6 and the like, in Step S140, the controller 20a determines whether the variable Vc is equal to or less than 49. When it is determined in Step S140 that the variable Vc is equal to or less than the maximum value of the LBAs (Step S140: YES), the controller 20a performs Step S120 again. When it is determined in Step S140 that the variable Vc is greater than the maximum value of the LBAs (Step S140: NO), the controller 20a performs Step S220 which will be described later.

When it is determined in Step S120 that the disk sector DS indicated by the variable β (Vc) is a defective disk sector DDS registered in the second defect list PL2 (Step S120: YES), the controller 20a sets the variable Vb to 1 (Step S150). The variable Vb is a variable for counting the number of continuous disk sectors DS continuously registered in the second defect list PL2. Subsequently to Step S150, the controller 20a increases the value of the variable Vc by 1 (Step S160). Subsequently to Step S160, the controller 20a determines whether the variable β (Vc) is registered in the second defect list PL2 (Step S170). The process of Step S170 is a determination process of determining whether the disk sector DS to which an LBA has been written is a defective disk sector DDS registered in the second defect list PL2. The determination method used in Step S170 is the same as the determination method used in Step S120. When it is determined in Step S170 that the disk sector DS indicated by the variable β (Vc) is registered in the second defect list PL2 (Step S170: YES), the controller 20a increases the variable Vb by 1 (Step S180). Subsequently to Step S180, the controller 20a performs Steps S160 and S170 again.

When it is determined in Step S170 that the disk sector DS indicated by the variable β (Vc) is not registered in the second defect list PL2 (Step S170: NO), the controller 20a sets the variable Va to a value obtained by adding the variable Vb to the current variable Va (Step S190). Subsequently to Step S190, the controller 20a increases the variable Vz by 1 (Step S200). Step S200 may be performed before Step S190. Subsequently to Step S200, the controller 20a writes the LBA number α and the added number Δ to a Vz-th position in the management table (Step S210). In Step S210, the controller 20a writes a value obtained by subtracting the variable Va from the variable Vc as the LBA number α to a Vz-th row in the management table. In Step S210, the controller 20a writes the variable Va as the added number Δ to the Vz-th row in the management table. By performing Step S210 whenever it is determined in Step S120 that the disk sector DS indicated by the variable β (Vc) is a defective disk sector DDS, the management table is prepared.

Before the second formatting process FP2 is performed, 0 as the LBA number α and 0 as the added number Δ are input in advance to a row in which the variable Vz is 0 in the management table. When the variable Vc is 0 and it is determined in Step S120 that the that the disk sector DS indicated by the variable β (Vc) is a defective disk sector DDS, the value obtained by subtracting the variable Va from the variable Vc, that is, the LBA number α registered in the management table, is 0 in Step S210. In this case, the controller 20a may register data in which the LBA number α is 0 and the added number Δ is the variable Va in the row in which the variable Vz is 1 or may return the variable Vz to 0 and register such data in a row in which the variable Vz is 0 through overwriting.

Subsequently to Step S210, the controller 20a performs the process of Step S140. When it is determined in Step S140 that the variable Vc is greater than the maximum value of the LBAs (Step S140: NO), the controller 20a determines whether the variable Va is greater than 0 (Step S220). In Step S220, the case in which the variable Va is 0 is a case in which there is no disk sector DS registered in the second defect list PL2.

When it is determined in Step S220 that the variable Va is 0 (Step S220: NO), the controller 20a updates generation information of data (Step S270). The generation information of data is generation information of user data UD which is recorded in the disk sector DS along with the user data when the user data UD is recorded in the disk sector DS. When the generation information of data is updated in the second formatting process FP2, the generation information recorded together when the user data UD is recorded in the disk sector DS after the second formatting process FP2 has been performed is different from the generation information recorded before the second formatting process FP2 has been performed. In this way, in the present embodiment, the second formatting process FP2 includes changing the generation information recorded in the disk sector DS along with the user data UD when the user data UD is recorded in each disk sector DS.

In the present embodiment, the control device 20 is configured to output a data pattern indicating an initialized state when user data UD with different generation information is recorded in the disk sectors DS at the time of reading access to the disk sectors DS. The data pattern indicating an initialized state is a data pattern that is set when the disk sector DS is formatted. The data pattern indicating the initialized state is, for example, a zero pattern including only zeros.

Subsequently to Step S270, the controller 20a ends the second formatting process FP2. Step S270 may be performed at any timing of the second formatting process FP2.

When it is determined in Step S220 that the variable Va is greater than 0 (Step S220: YES), the controller 20a determines whether an LBA indicated by the variable Vc is written (Step S230). In Step S230, the variable Vc is greater than the maximum value of the LBAs designated by the host device 40. Accordingly, when only the LBAs equal to or less than the maximum value of the LBAs designated by the host device 40 are written to the disk sectors DS in the first formatting process FP1, the LBA indicated by the variable Vc is not written to the disk sector DS in Step S220. On the other hand, when the LBAs greater than the maximum value of the LBAs designated by the host device 40 are written to the disk sectors DS in the first formatting process FP1, there may be a disk sector DS to which the LBA indicated by the variable Vc has been written in Step S230.

When it is determined in Step S230 that the LBA indicated by the variable Vc has not been written (Step S230: NO), the controller 20a performs a writing process of writing the LBA to the disk sector DS (Step S240). That is, the second formatting process FP2 includes the writing process of Step S240. The writing process is a process of writing another LBA to a disk sector DS in the second recording area ST2 when the other LBA which is replaced using the management table has not been written to the disk sector DS in the recording area ST. In Step S240, the controller 20a writes the LBA indicated by the variable Vc to a next disk sector DS of the disk sector DS to which the maximum LBA out of the currently written LBAs has been written in the order of writing the LBAs in the first formatting process FP1. In the examples illustrated in FIGS. 4 and 6, when the LBA which is written in Step S240 is No. 50, the controller 20a writes the LBA of No. 50 to a disk sector DS adjacent to the disk sector DS to which the LBA of No. 49 has been written out of the disk sectors DS in the second recording area ST2.

In Step S240, the controller 20a performs the writing process with reference to the first defect list PL1. In Step S240, the controller 20a writes the LBA to a next disk sector DS of the disk sector DS when the disk sector DS to which the LBA is to be written is registered in the first defect list PL1.

Subsequently to Step S240, the controller 20a performs Step S250. When it is determined in Step S230 that the LBA indicated by the variable Vc is written (Step S230: YES), the controller 20a does not perform Step S240 but performs Step S250.

In Step S250, the controller 20a determines whether the variable Vc is less than a value obtained by adding the variable Va to the maximum value of the LBAs designated by the host device 40. When it is determined in Step S250 that the variable Vc is less than a value obtained by adding the variable Va to the maximum value (Max. LBA) of the LBAs designated by the host device 40 (Step S250: YES), the controller 20a increases the variable Vc by 1 (Step S260). Subsequently to Step S260, the controller 20a performs Step S230 again. When it is determined in Step S250 that the variable Vc is equal to the value obtained by adding the variable Va to the maximum value of the LBAs designated by the host device 40 (Step S250: NO), the controller 20a performs Step S270. After Step S270 has been performed, the controller 20a ends the second formatting process FP2.

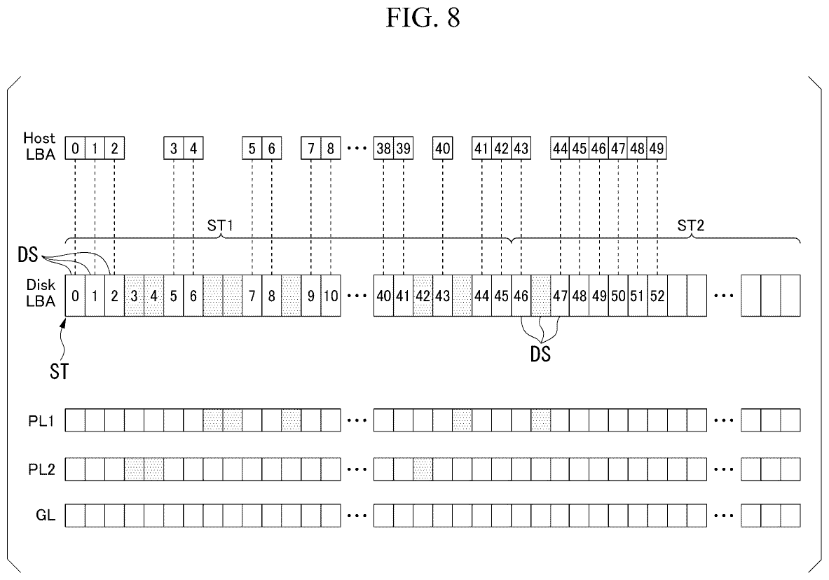

FIG. 8 is a diagram illustrating a relationship between LBAs designated by the host device 40 after the second formatting process FP2 has been performed and LBAs written to the disk sectors DS. FIG. 8 illustrates an example in which the second formatting process FP2 has been performed on the recording area ST illustrated in FIG. 6. As illustrated in FIG. 8, when the second formatting process FP2 is performed, data registered in the follow-up defect list GL is transferred to the second defect list PL2, and the data registered in the follow-up defect list GL is deleted. In the example illustrated in FIG. 8, it is assumed that the management table shown in Table 1 is prepared. In the example illustrated in FIG. 8, the disk sectors DS to which the LBAs of Nos. 3, 4, and 42 have been written are registered in the second defect list PL2. Accordingly, for example, when the LBA designated by the host device 40 is No. 3, the controller 20a originally has to access the disk sector DS to which the LBA of No. 3 has been written, but replaces the LBA of No. 3 with the LBA of No. 5 in which 2 is added as the added number Δ on the basis of the management table and accesses the disk sector DS to which the LBA of No. 5 has been written. For example, when the LBA designated by the host device 40 is No. 43, the controller 20a originally has to access the disk sector DS to which the LBA of No. 43 has been written, but replaces the LBA of No. 43 with the LBA of No. 46 in which 3 is added as the added number Δ on the basis of the management table and accesses the disk sector DS to which the LBA of No. 46 has been written.

In FIG. 8, since three disk sectors DS are registered in the second defect list PL2, the LBAs are newly written to the three disk sectors DS in comparison with the recording area ST illustrated in FIG. 6. Specifically, LBAs of Nos. 50, 51, and 52 are sequentially written to three disk sectors DS arranged subsequent to the disk sector DS to which the LBA of No. 49 has been written. For example, when the LBA designated by the host device 40 is No. 49 which is the maximum value, the controller 20a replaces the LBA of No. 49 with the LBA of No. 52 in which 3 is added as the added number Δ on the basis of the management table and accesses the disk sector DS to which the LBA of No. 52 has been written.

The control method according to the present embodiment is a control method that is performed by the control device 20. At least some functions of the control device 20 are realized, for example, by causing the controller 20a to execute a program, that is, software, stored in the disk 10 or the nonvolatile memory 33. The program is a program for causing the control device 20 which is a computer to perform the control method according to the present embodiment. At least some functions of the control device 20 may be realized, for example, by hardware including a circuit unit such as a large scale integration (LSI) circuit, an application-specific integrated circuit (ASIC), a field-programmable gate array (FPGA), and a graphics processing unit (GPU) or may be cooperatively realized by software and hardware. The control device 20 may be constituted by a plurality of devices.

A medium in which the program for causing the control device 20 which is a computer to perform the control method according to the present embodiment is stored is not particularly limited and may be a storage medium other than the disk 10 or the nonvolatile memory 33. The storage medium in which the program is stored may be the same as the storage medium in which the first defect list PL1, the second defect list PL2, and the follow-up defect list GL are stored or may be a storage medium different therefrom. The storage medium in which the program is stored may be another storage medium included in the disk drive 100 or may be a storage medium provided separately from the disk drive 100. The storage medium is, for example, a flexible disk, a magneto-optical disc, a random access memory (RAM), a read only memory (ROM), a CD-ROM, a hard disk drive (HDD), a solid state drive (SSD), or a flash memory. The program for causing the control device 20 which is a computer to perform the control method according to the present embodiment may be transmitted to the control device 20 via a telecommunication line. The storage medium in which the first defect list PL1, the second defect list PL2, and the follow-up defect list GL are stored may be a storage medium other than the disk 10 and the nonvolatile memory 33. The storage medium in which the first defect list PL1, the second defect list PL2, and the follow-up defect list GL are stored may be a storage medium that is provided outside of the disk drive 100. In this case, the disk drive 100 may communicate with the storage medium via a telecommunication line and acquire various types of information including information of the defect lists from the storage medium. Two or more storage media out of a storage medium in which the first defect list PL1 is stored, a storage medium in which the second defect list PL2 is stored, and a storage medium in which the follow-up defect list GL is stored may be different storage media.

According to the present embodiment, the control device 20 is a control device for a disk drive 100 including a recording area ST including a plurality of disk sectors DS. The control device 20 includes a controller 20a. The recording area ST includes a first recording area ST1 including two or more disk sectors DS. A plurality of logical block addresses (LBAs) are written to the disk sectors DS other than disk sectors DS registered in a first defect list PL1 out of the disk sectors DS in the first recording area ST1. The controller 20a is configured to perform a second formatting process FP2 based on a second defect list PL2 different from the first defect list PL1. In other words, a control method for the disk drive 100 includes the second formatting process FP2. The disk sectors DS determined to be defective after the LBAs have been written to the disk sectors DS are registered in the second defect list PL2. The second formatting process FP2 includes a determination process of determining whether a disk sector DS to which an LBA has been written is a defective disk sector DDS registered in the second defect list PL2. The second formatting process FP2 includes preparing a management table for sequentially re-assigning the LBAs designated by a host device 40 sending an instruction to the disk drive 100 to the LBAs written to the disk sectors DS other than the defective disk sector DDS. The management table includes information that is used to replace the LBAs equal to or greater than a minimum value of the LBAs written to the defective disk sectors DDS out of the LBAs designated by the host device 40 with other LBAs written to the disk sectors DS other than the defective disk sectors DDS. In this way, in the second formatting process FP2, the LBAs designated by the host device 40 can be sequentially re-assigned to the disk sectors DS by preparing the management table for replacing at least some of the LBAs designated by the host device 40 with other LBAs originally written to the disk sectors DS. Accordingly, when certain LBAs are written in advance to the other disk sectors DS to be replaced in the second formatting process FP2, the controller 20a does not need to write the certain LBAs to the other disk sectors DS again. As a result, through the second formatting process FP2, the controller 20a can re-assign the LBAs designated by the host device 40 to the LBAs written to the disk sectors DS other than the defective disk sector DDS without re-writing all the LBAs to the disk sectors DS. Accordingly, according to the present embodiment, it is possible to curb extending of a time required for the re-formatting process.

For example, when the number of disk sectors DS registered in the follow-up defect list GL increases, the number of processes of temporarily moving the head 11 to the disk sector DS which is a replacement result based on the follow-up defect list GL and then returning the head 11 to the original position while sequentially reading the LBAs or the like increases. Accordingly, as the number of disk sectors DS registered in the follow-up defect list GL increases, sequential performance of the disk drive 100 decreases. In this case, when a re-formatting process of writing the LBAs into the disk sectors other than the disk sectors DS registered in the follow-up defect list GL is performed, it is possible to improve the sequential performance of the disk drive 100. However, since a time required for processing the re-formatting process extends, there is a problem in that convenience for a user is poor. On the other hand, according to the present embodiment, it is possible to curb extending of the time required for the re-formatting process by performing the second formatting process FP2 as described above. Accordingly, when the sequential performance of the disk drive 100 decreases, a user can improve the sequential performance of the disk drive 100 for a short time by causing the controller 20a to perform the second formatting process FP2.

For example, a manufacturer manufacturing the disk drive 100 may have to perform a re-formatting process before the disk drive 100 on which the first formatting process FP1 has been performed is shipped. In this case, the manufacturer of the disk drive 100 can perform the process of re-formatting the disk drive 100 for a short time by causing the disk drive 100 to perform the second formatting process FP2. Accordingly, it is possible to curb extending of a time required until the disk drive 100 is shipped.

According to the present embodiment, the recording area ST includes a second recording area ST2 including two or more disk sectors. The second formatting process FP2 includes a process of writing other LBAs to the disk sectors DS in the second recording area ST2 when the other LBAs to be replaced using the management table are not written to the disk sectors in the recording area ST. Accordingly, when there is an unavailable disk sector DS and a disk sector DS to which an LBA can be written remains in the second recording area ST2, the controller 20a can re-assign all the LBAs designated by the host device 40 to the disk sectors DS through the second formatting process FP2.

According to the present embodiment, the controller 20a is configured to perform the first registration process of registering a disk sector DS determined to be defective after the LBAs have been written to the disk sectors DS in the second defect list PL2. That is, the control method for the disk drive 100 includes the first registration process. Accordingly, for example, when the replacement process based on the follow-up defect list GL does not need to be performed such as before the disk drive 100 is shipped, the controller 20a can directly register the disk sector DS with a defect occurring later in the second defect list PL2 through the first registration process and perform the second formatting process FP2 based on the second defect list PL2. As a result, it is not necessary to perform the process of Step S100. Accordingly, it is possible to further curb extending of a time required for the second formatting process FP2.

According to the present embodiment, the controller 20a is configured to perform the second registration process of registering a disk sector DS determined to be defective after the LBAs have been written to the disk sectors DS in the follow-up defect list GL which is other than the first defect list PL1 and the second defect list PL2. The controller 20a is configured to perform the replacement process of replacing the disk sectors DS registered in the follow-up defect list GL with the other disk sectors DS. That is, the control method for the disk drive 100 includes the second registration process and the replacement process. A disk sector DS determined to be defective after the LBAs have been written to the disk sectors DS is registered in the follow-up defect list GL. Accordingly, by registering a disk sector DS which becomes defective when a user uses the disk drive 100 in the follow-up defect list GL through the second registration process, another disk sector DS can be used instead of the disk sector DS which becomes defective through the replacement process. Accordingly, it is possible to curb a decrease in convenience for a user. The second formatting process FP2 includes registering the disk sectors DS registered in the follow-up defect list GL in the second defect list PL2 and then performing the determination process on the basis of the second defect list PL2 when the disk sectors DS are registered in the follow-up defect list GL. Accordingly, the disk sectors DS registered in the follow-up defect list GL can be transferred to the second defect list PL2 through the second formatting process FP2. As a result, by performing the second formatting process FP2, the controller 20a can re-assign the LBAs to the disk sectors DS other than the disk sectors DS registered in the follow-up defect list GL as described above.

According to the present embodiment, the second formatting process FP2 includes changing generation information which is recorded in the disk sectors DS along with user data UD when the user data UD is recorded in the disk sectors DS. Accordingly, the generation information of user data UD which is recorded in the disk sectors DS after the second formatting process FP2 has been completed is different from the generation information of the user data UD recorded in the disk sectors DS before the second formatting process FP2 has been performed. The control device 20 is configured to output a data pattern indicating an initialized state when user data UD with the different generation information is recorded in a disk sector DS at the time of reading access to the disk sector DS. That is, the control method for the disk drive 100 includes outputting the data pattern indicating an initialized state when user data UD with different generation information is recorded in a disk sector DS at the time of reading access to the disk sector DS. Accordingly, even when user data UD is recorded in a disk sector DS to which an LBA with a replaced number on the basis of the management table before the second formatting process FP2 is performed, the user data UD is not read after the second formatting process FP2 has been performed. As a result, it is possible to curb erroneous reading of the user data UD recorded in the LBA with a number different from that of the LBA designated by the host device 40. Since a disk sector DS in which user data UD with old generation information is recorded does not need to be replaced with a formatted pattern such as a zero pattern in the second formatting process FP2, it is possible to further curb extending of a time required for the second formatting process FP2.

The second formatting process FP2 includes setting a data pattern of a disk sector DS to a data pattern indicating an initialized state when the data pattern of the disk sector DS to which the LBA has been written is not the data pattern indicating the initialized state. In this case, after the second formatting process FP2 has been completed, the data patterns of all the disk sectors DS to which the LBAs have been written are set to the data pattern indicating the initialized state. Accordingly, even when the LBAs are replaced on the basis of the management table and the disk sectors DS are accessed, user data UD corresponding to erroneous LBAs is not read. In this case, the process of Step S270 may not be performed.

When the number of disk sectors DS registered in the second defect list PL2 is larger than the number of disk sectors DS to which an LBA has not been written out of the disk sectors DS in the second recording area ST2, the controller 20a may write LBAs to available disk sectors DS by a writable amount and may not write some LBAs. When the performance of a certain head 11 becomes lower than predetermined performance, the controller 20a may register all the disk sectors DS in the recording surface 10a corresponding to the head 11 in the second defect list PL2. When all the disk sectors DS in the recording surface 10a are registered in the second defect list PL2, the controller 20a may decrease the number of available LBAs out of the LBAs designated by the host device 40 by the number of disk sectors DS in the recording surface 10a and may not write the LBAs which are replaced to correspond to the decreased LBAs to the disk sectors DS in the second recording area ST2.

According to at least one embodiment described above, the control device is a control device for a disk drive including a recording area including a plurality of disk sectors. The control device includes a controller. The recording area includes a first recording area including two or more disk sectors. A plurality of logical block addresses are written to disk sectors other than disk sectors registered in a first defect list out of the disk sectors in the first recording area. The controller is configured to perform a formatting process based on a second defect list different from the first defect list. The disk sectors determined to be defective after the logical block addresses have been written to the disk sectors are registered in the second defect list. The formatting process includes a determination process of determining whether a disk sector to which a logical block address has been written is a defective disk sector registered in the second defect list. The formatting process includes preparing a management table for sequentially re-assigning the logical block addresses designated by a host device sending an instruction to the disk drive to the logical block addresses written to the disk sectors other than the defective disk sector. The management table includes information that is used to replace the logical block addresses equal to or greater than a minimum value of the logical block addresses written to the defective disk sectors out of the logical block addresses designated by the host device with other logical block addresses written to the disk sectors other than the defective disk sectors. Accordingly, through the formatting process, the controller can re-assign the logical block addresses designated by the host device to the logical block addresses written to the disk sectors other than the defective disk sectors without re-writing all the logical block addresses to the disk sectors. As a result, it is possible to curb extending of a time required for a re-formatting process.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control device for a disk drive including a recording area including a plurality of disk sectors, the control device comprising a controller,
wherein the recording area includes a first recording area including two or more of the disk sectors,
wherein a plurality of logical block addresses are written to disk sectors other than disk sectors registered in a first defect list out of the disk sectors in the first recording area,
wherein the controller is configured to perform a formatting process based on a second defect list different from the first defect list,
wherein the disk sectors determined to be defective after the logical block addresses have been written to the disk sectors are registered in the second defect list,
wherein the formatting process includes
a determination process of determining whether a disk sector to which a logical block address has been written is a defective disk sector registered in the second defect list; and
a process of preparing a management table for sequentially re-assigning the logical block addresses designated by a host device sending an instruction to the disk drive to the logical block addresses written to the disk sectors other than the defective disk sector, and
wherein the management table includes information that is used to replace the logical block addresses equal to or greater than a minimum value of the logical block addresses written to the defective disk sectors out of the logical block addresses designated by the host device with other logical block addresses written to the disk sectors other than the defective disk sectors.

2. The control device according to claim 1, wherein the recording area includes a second recording area including two or more of the disk sectors, and
wherein the formatting process includes a process of writing the other logical block addresses to the disk sectors in the second recording area when the other logical block addresses to be replaced using the management table are not written to the disk sectors in the recording area.

3. The control device according to claim 1, wherein the controller is configured to perform a first registration process of registering the disk sectors determined to be defective after the logical block addresses have been written to the disk sectors in the second defect list.

4. The control device according to claim 1, wherein the controller is configured to perform:
a second registration process of registering the disk sectors determined to be defective after the logical block addresses have been written to the disk sectors in a follow-up defect list other than the first defect list and the second defect list; and
a replacement process of replacing the disk sectors registered in the follow-up defect list with the other disk sectors,
wherein the disk sectors determined to be defective after the logical block addresses have been written to the disk sectors are registered in the follow-up defect list, and
wherein the formatting process includes registering the disk sectors registered in the follow-up defect list in the second defect list and then performing the determination process on the basis of the second defect list when the disk sectors are registered in the follow-up defect list.

5. The control device according to claim 1, wherein the formatting process includes changing generation information which is recorded in the disk sectors along with data when the data is recorded on the disk sectors, and
wherein the controller is configured to output a data pattern indicating an initialized state when data with the different generation information is recorded on the disk sector at the time of reading access to the disk sector.

6. The control device according to claim 1, wherein the formatting process includes setting a data pattern of the disk sector to a data pattern indicating an initialized state when the data pattern of the disk sector to which the logical block address has been written is not the data pattern indicating the initialized state.

7. A disk drive including a recording area including a plurality of disk sectors, the disk drive comprising:
a disk;
a head configured to read data recorded on the disk and to write data to the disk; and
a control device,
wherein the control device includes a controller,
wherein the recording area includes a first recording area including two or more of the disk sectors,
wherein a plurality of logical block addresses are written to disk sectors other than disk sectors registered in a first defect list out of the disk sectors in the first recording area,
wherein the controller is configured to perform a formatting process based on a second defect list different from the first defect list,
wherein the disk sectors determined to be defective after the logical block addresses have been written to the disk sectors are registered in the second defect list,
wherein the formatting process includes
a determination process of determining whether a disk sector to which a logical block address has been written is a defective disk sector registered in the second defect list; and
a process of preparing a management table for sequentially re-assigning the logical block addresses designated by a host device sending an instruction to the disk drive to the logical block addresses written to the disk sectors other than the defective disk sector, and
wherein the management table includes information that is used to replace the logical block addresses equal to or greater than a minimum value of the logical block addresses written to the defective disk sectors out of the logical block addresses designated by the host device with other logical block addresses written to the disk sectors other than the defective disk sectors.

8. A control method for a disk drive including a recording area including a plurality of disk sectors,
wherein the recording area includes a first recording area including two or more of the disk sectors,
wherein a plurality of logical block addresses are written to disk sectors other than disk sectors registered in a first defect list out of the disk sectors in the first recording area,
wherein the control method comprises a formatting process based on a second defect list different from the first defect list,
wherein the disk sectors determined to be defective after the logical block addresses have been written to the disk sectors are registered in the second defect list,
wherein the formatting process includes
a determination process of determining whether a disk sector to which a logical block address has been written is a defective disk sector registered in the second defect list; and
a process of preparing a management table for sequentially re-assigning the logical block addresses designated by a host device sending an instruction to the disk drive to the logical block addresses written to the disk sectors other than the defective disk sector, and
wherein the management table includes information that is used to replace the logical block addresses equal to or greater than a minimum value of the logical block addresses written to the defective disk sectors out of the logical block addresses designated by the host device with other logical block addresses written to the disk sectors other than the defective disk sectors.

9. The control method according to claim 8, wherein the recording area includes a second recording area including two or more of the disk sectors, and
wherein the formatting process includes a process of writing the other logical block addresses to the disk sectors in the second recording area when the other logical block addresses to be replaced using the management table are not written to the disk sectors in the recording area.

10. The control method according to claim 8, further comprising a first registration process of registering the disk sectors determined to be defective after the logical block addresses have been written to the disk sectors in the second defect list.

11. The control method according to claim 8, further comprising:
a second registration process of registering the disk sectors determined to be defective after the logical block addresses have been written to the disk sectors in a follow-up defect list other than the first defect list and the second defect list; and
a replacement process of replacing the disk sectors registered in the follow-up defect list with the other disk sectors, and
wherein the formatting process includes registering the disk sectors registered in the follow-up defect list in the second defect list and then performing the determination process on the basis of the second defect list when the disk sectors are registered in the follow-up defect list.

12. The control method according to claim 8, wherein the formatting process includes changing generation information which is recorded in the disk sectors along with data when the data is recorded on the disk sectors, and
wherein the control method further comprises outputting a data pattern indicating an initialized state when data with the different generation information is recorded on the disk sector at the time of reading access to the disk sector.

13. The control method according to claim 8, wherein the formatting process includes setting a data pattern of the disk sector to a data pattern indicating an initialized state when the data pattern of the disk sector to which the logical block address has been written is not the data pattern indicating the initialized state.

14. A storage medium non-transitorily storing a software program which is able to be executed by a computer,
wherein the computer performs a control method for a disk drive including a recording area including a plurality of disk sectors when the software program is executed,
wherein the recording area includes a first recording area including two or more of the disk sectors,
wherein a plurality of logical block addresses are written to disk sectors other than disk sectors registered in a first defect list out of the disk sectors in the first recording area,
wherein the control method comprises a formatting process based on a second defect list different from the first defect list,
wherein the disk sectors determined to be defective after the logical block addresses have been written to the disk sectors are registered in the second defect list,
wherein the formatting process includes
a determination process of determining whether a disk sector to which a logical block address has been written is a defective disk sector registered in the second defect list, and
a process of preparing a management table for sequentially re-assigning the logical block addresses designated by a host device sending an instruction to the disk drive to the logical block addresses written to the disk sectors other than the defective disk sector, and
wherein the management table includes information that is used to replace the logical block addresses equal to or greater than a minimum value of the logical block addresses written to the defective disk sectors out of the logical block addresses designated by the host device with other logical block addresses written to the disk sectors other than the defective disk sectors.
